(19) United States
(12) Patent Application Publication
(10) Pub. No.: US 2024/0259042 A1
(43) Pub. Date: Aug. 1, 2024

(54) Cell Phone Case Device with Knife Blade

(71) Applicant: Emily Stevens, Longview, TX (US)

(72) Inventor: Emily Stevens, Longview, TX (US)

(21) Appl. No.: 18/416,072

(22) Filed: Jan. 18, 2024

Related U.S. Application Data
(60) Provisional application No. 63/441,267, filed on Jan. 26, 2023.

(51) Int. Cl. H04B 1/3888; B26B 1/08; F41B 13/08; H04M 1/21

(52) U.S. Cl. CPC H04B 1/3888; B26B 1/08; F41B 13/08; H04M 1/21

(57) ABSTRACT

A cell phone case device with knife blade is provided. The device is comprised of a cell phone case body with an integrated knife that can be extended from/retracted into the body via a spring deployment mechanism. The knife and mechanism may be removed from the body in different embodiments.

### CROSS-REFERENCE TO RELATED APPLICATION

The present application claims priority to, and the benefit of, U.S. Provisional Application No. 63/441,267, which was filed on Jan. 26, 2023, and is incorporated herein by reference in its entirety.

### FIELD OF THE INVENTION

The present invention relates generally to the field of cell phone cases. More specifically, the present invention relates to a cell phone case device with knife blade comprised of a cell phone case with an extendable and retractable knife blade, wherein the phone acts as the handle for the knife. Accordingly, the present disclosure makes specific reference thereto. Nonetheless, it is to be appreciated that aspects of the present invention are also equally applicable to other like applications, devices, and methods of manufacture.

### BACKGROUND

Knives are incredibly versatile tools with a wide range of applications, making them indispensable in various situations. More specifically, knives can be used as effective defense tools, offering a sense of security and protection in unpredictable circumstances. They are particularly useful in self-defense situations, where having a quick and reliable means of protection can make a significant difference.

Beyond their defensive capabilities, knives are also everyday utility tools that can be used for mundane tasks such as opening mail or slicing through the tape and bindings of delivered packages. Their practicality extends to outdoor activities as well. For instance, while fishing, a knife is essential for cutting lines, cleaning fish, or even preparing bait. The precision and efficiency that a knife provides in these activities are unmatched by most other tools.

Despite their utility, individuals often face the challenge of remembering to carry their utility knife with them. It's not uncommon to forget or misplace a knife during the hustle and bustle of daily life. This can be inconvenient, especially when you find yourself in a situation where a knife would have been incredibly useful.

Therefore, there exists a long-felt need in the art for an improved knife. There also exists a long-felt need in the art for a cell phone case device with knife blade. More specifically, there exists a long-felt need in the art for a cell phone case device with knife blade that provides a concealable, convenient knife blade that cannot be easily lost.

The subject matter disclosed and claimed herein, in one embodiment thereof, comprises a cell phone case device with knife blade. The device is comprised of a cell phone case body with an integrated knife that can be extended from/retracted into the body via a spring deployment mechanism. The knife and mechanism may be removed from the body in different embodiments.

In this manner, the cell phone case device with knife blade of the present invention accomplishes all the foregoing objectives and provides an improved knife. More specifically, the device provides a cell phone case with a retractable/extendable knife blade. In this manner, the device provides a concealable, convenient knife blade that cannot be easily lost.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone case device with knife blade comprised of a cell phone case body with a retractable blade that can be extended from the body via at least one deploying mechanism.

The body may be any style, shape, size, and configuration of cell phone case known in the art. The interior surface of the body is comprised of at least one blade attached to at least one deploying mechanism that allows the blade to extend outwards from the body via at least one opening of the body.

The deploying mechanism is preferably a spring mechanism that is compressed when the blade is within the body. The body may be comprised of at least one button that when pressed releases the spring to extend the blade from the body. The blade then preferably is automatically locked in said extended position via at least one locking member. To retract the blade, a user can press at least one button which disengages the locking member to allow the blade to be manually pushed or automatically retracted into the body. Once within the body, the locking member may be automatically or manually re-engaged (via a locking button) to ensure the blade does not extend from the body inadvertently.

Further, in one embodiment the exterior surface of the body is comprised of at least one light and at least one speaker. The light and/or speaker can be activated via pressing at least one panic button in a self-defense situation.

The present invention is also comprised of a method of using the device. First, a device is provided comprised of a cell phone case body comprised of at least one blade that can be extended from and retracted into the body via at least one deploying mechanism. Then, a user can place the body around a cell phone. Next, a user can press a button to activate the mechanism to extend the blade from the body via at least one opening of the body. A user can then press a button to disengage a locking member to allow the blade to be automatically or manually retracted into the body via the mechanism.

The present invention is also comprised of a second method of using the device. First, a device is provided comprised of a cell phone case body comprised of at least one blade that can be extended from and retracted into the body via at least one deploying mechanism, at least one light, at least one speaker, and at least one battery. Then, a user can place the body around a cell phone. Then, a user can press a button to activate the light and/or speaker. Next, a user can press a button to activate the mechanism to extend the blade from the body via at least one opening of the body. A user can then press a button to disengage a locking member to allow the blade to be automatically or manually retracted into the body via the mechanism.

Accordingly, the cell phone case device with knife blade of the present invention is particularly advantageous as it provides an improved knife. More specifically, the device provides a cell phone case with a retractable/extendable knife blade. In this manner, the device provides a concealable, convenient knife blade that cannot be easily lost and overcomes the limitations of existing knives and knife-carrying methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cell phone case device with knife blade of the present invention while the blade is extended from the body in accordance with the disclosed architecture;

FIG. 2 illustrates a perspective view of one potential embodiment of a cell phone case device with knife blade of the present invention while the blade is retracted within the body in accordance with the disclosed architecture;

FIG. 3 illustrates a flowchart of a method of using one potential embodiment of a cell phone case device with knife blade of the present invention in accordance with the disclosed architecture; and

FIG. 4 illustrates a flowchart of a method of using one potential embodiment of a cell phone case device with knife blade of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved knife. There also exists a long-felt need in the art for a cell phone case device with knife blade. More specifically, there exists a long-felt need in the art for a cell phone case device with knife blade that provides a concealable, convenient knife blade that cannot be easily lost.

The present invention, in one exemplary embodiment, is comprised of a cell phone case device with knife blade comprised of a cell phone case body with a retractable blade that can be extended from the body via at least one deploying mechanism.

The body may be any style, shape, size, and configuration of cell phone case known in the art, wherein an interior surface of the body is comprised of at least one blade attached to at least one deploying mechanism that allows the blade to extend outwards from the body via at least one opening of the body.

The deploying mechanism is preferably a spring mechanism that is compressed when the blade is within the body. The body may be comprised of at least one button that when pressed releases the spring to extend the blade from the body. The blade then preferably is automatically locked in said extended position via at least one locking member. To retract the blade, a user can press at least one button which disengages the locking member to allow the blade to be manually pushed or automatically retracted into the body. Once within the body, the locking member may be automatically or manually re-engaged (via a locking button) to ensure the blade does not extend from the body inadvertently.

Further, in one embodiment the exterior surface of the body is comprised of at least one light and at least one speaker. The light and/or speaker can be activated via pressing at least one panic button in a self-defense situation.

The present invention is also comprised of a method of using the device. First, a device is provided comprised of a cell phone case body comprised of at least one blade that can be extended from and retracted into the body via at least one deploying mechanism. Then, a user can place the body around a cell phone. Next, a user can press a button to activate the mechanism to extend the blade from the body via at least one opening of the body. A user can then press a button to disengage a locking member to allow the blade to be automatically or manually retracted into the body via the mechanism.

The present invention is also comprised of a second method of using the device. First, a device is provided comprised of a cell phone case body comprised of at least one blade that can be extended from and retracted into the body via at least one deploying mechanism, at least one light, at least one speaker, and at least one battery. Then, a user can place the body around a cell phone. Then, a user can press a button to activate the light and/or speaker. Next, a user can press a button to activate the mechanism to extend the blade from the body via at least one opening of the body. A user can then press a button to disengage a locking member to allow the blade to be automatically or manually retracted into the body via the mechanism.

Accordingly, the cell phone case device with knife blade of the present invention is particularly advantageous as it provides an improved knife. More specifically, the device provides a cell phone case with a retractable/extendable knife blade. In this manner, the device provides a concealable, convenient knife blade that cannot be easily lost and overcomes the limitations of existing knives and knife-carrying methods known in the art.

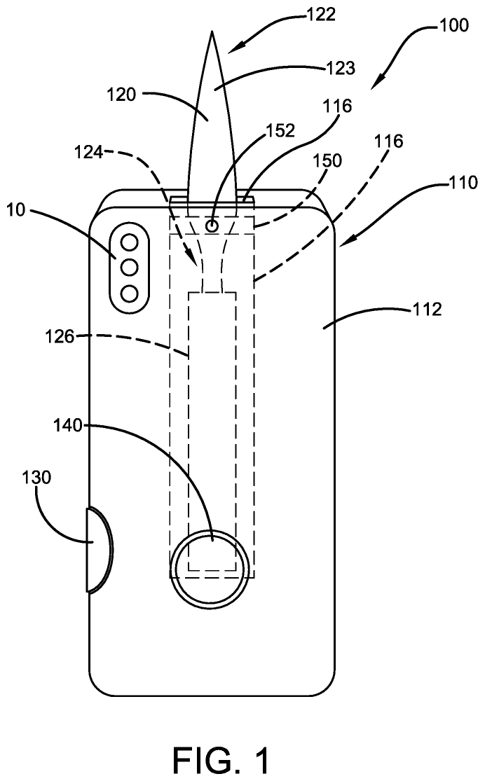

Referring initially to the drawings, FIG. 1 illustrates a perspective view of one potential embodiment of a cell phone case device with knife blade 100 of the present invention while the blade 120 is extended from the body 110 in accordance with the disclosed architecture. The device 100 is comprised of a cell phone case body 110 with a retractable blade 120 that can be extended from the body 110 via at least one deploying mechanism 126.

The body 110 may be any style, shape, size, and configuration of cell phone case known in the art. The interior surface 114 of the body 110 is comprised of at least one blade 120 attached to at least one deploying mechanism 126 that allows the blade to extend outwards from the body 110 via at least one opening 116 of the body 110. The blade 120 may be any style of blade known in the art. The blade 120 preferably has a pointed first end 122 with at least one cutting edge 123. The second end 124 of the blade 120 may fixedly or removably attach to the deploying mechanism 126. In one embodiment, the mechanism 126 may also be removable from the interior surface 114 of the body 110. However, the mechanism 126 is not removable when at least one safety button 152 and/or lock 150 is engaged.

The deploying mechanism 126 is preferably a spring mechanism that is compressed when the blade 120 is within the body 110. The body 110 may be comprised of at least one button 130 that when pressed releases the spring to extend the blade 120 from the body 110. The blade 120 then preferably is automatically locked in said extended position via at least one locking member 150 of any type known in the art. In one embodiment, the button 130 is comprised of two buttons, one on each side of the body 110, that must be simultaneously squeezed to in order to deploy the blade 120. The ability to retract the blade 120 is not affected by whether the safety 152 button is engaged/disengaged.

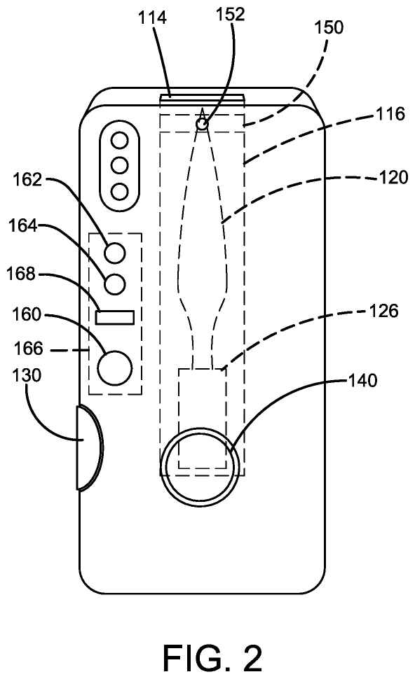

To retract the blade, a user can press at least one button 140 which disengages the locking member 150 to allow the blade 120 to be manually pushed or automatically retracted into the body 110, as seen in FIG. 2. In a different embodiment, pressing/squeezing the button(s) 130 again will retract the blade 120. Once within the body 110, the locking member 150 may be automatically or manually re-engaged (via a safety button 152) to ensure the blade 120 does not extend from the body 110 inadvertently. In one embodiment, the blade 120 cannot be extended via the button 130 unless the safety button 152 has been pressed to disengage the locking member 150.

In one embodiment, the exterior surface 112 of the body 110 is comprised of at least one light 162 and at least one speaker 164. The light 162 and/or speaker 164 can be activated via pressing at least one panic button 160 in a self-defense situation. The button 160 may not activate unless the safety button 152 has been pressed. During activation, the light 162 may intermittently or continuously illuminate in any color and the speaker 164 may produce a constant or intermittent alarm, sound, etc. The light 162 and speaker 164 may be powered by at least one battery 166. The battery 166 may be removable or non-removable from the body 110 in different embodiments. The battery 166 may also be rechargeable or disposable. In a non-removable and rechargeable embodiment, the battery 166 may be comprised of at least one charging port 168, such as, but not limited to, a USB port. In one embodiment, the battery 166 may be wirelessly charged by the cell phone the body 110 surrounds.

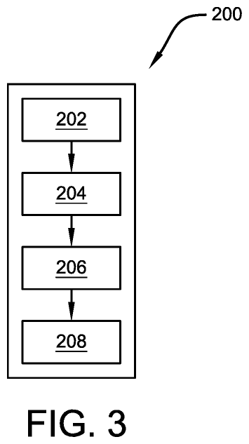

The present invention is also comprised of a method of using 200 the device 100, as seen in FIG. 3. First, a device 100 is provided comprised of a cell phone case body 110 comprised of at least one blade 120 that can be extended from and retracted into the body 110 via at least one deploying mechanism 126 [Step 202]. Then, a user can place the body 110 around a cell phone 10 [Step 204]. Next, a user can press a button 130 to activate the mechanism 126 to extend the blade 120 from the body 110 via at least one opening 116 of the body 110 [Step 206]. A user can then press a button 140 to disengage a locking member 150 to allow the blade 120 to be automatically or manually retracted into the body 110 via the mechanism 126 [Step 208].

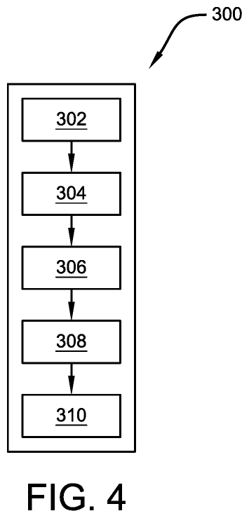

The present invention is also comprised of a second method of using 300 the device 100, as seen in FIG. 4. First, a device 100 is provided comprised of a cell phone case body 110 comprised of at least one blade 120 that can be extended from and retracted into the body 110 via at least one deploying mechanism 126, at least one light 162, at least one speaker 164, and at least one battery 166 [Step 302]. Then, a user can place the body 110 around a cell phone 10 [Step 304]. Then, a user can press a button 160 to activate the light 162 and/or speaker 164 [Step 306]. Next, a user can press a button 130 to activate the mechanism 126 to extend the blade 120 from the body 110 via at least one opening 116 of the body 110 [Step 308]. A user can then press a button 140 to disengage a locking member 150 to allow the blade 120 to be automatically or manually retracted into the body 110 via the mechanism 126 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cell phone case device with knife blade” and “device” are interchangeable and refer to the cell phone case device with knife blade 100 of the present invention.

Notwithstanding the foregoing, the cell phone case device with knife blade 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cell phone case device with knife blade 100 as shown in the FIGS. are for illustrative purposes only, and that many other sizes and shapes of the cell phone case device with knife blade 100 are well within the scope of the present disclosure. Although the dimensions of the cell phone case device with knife blade 100 are important design parameters for user convenience, the cell phone case device with knife blade 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cell phone case device with knife blade comprising:
a cell phone case body comprised of an opening;
a blade attached to a deploying mechanism, the deploying mechanism attached to the body;
a first button;
a second button;
a third button; and
a locking member.

2. The cell phone case device with knife blade of claim 1, wherein the blade is comprised of a pointed first end.

3. The cell phone case device with knife blade of claim 1, wherein the blade is comprised of a cutting edge.

4. The cell phone case device with knife blade of claim 1, wherein the blade is removably attached to the deploying mechanism.

5. The cell phone case device with knife blade of claim 1, wherein the deploying mechanism is removably attached to the body mechanism.

6. The cell phone case device with knife blade of claim 1, wherein the deploying mechanism is comprised of a spring.

7. The cell phone case device with knife blade of claim 1, wherein the locking member locks the blade in an extended or a retracted position relative to the body.

8. The cell phone case device with knife blade of claim 1, wherein the first button disengages the locking member when pressed.

9. The cell phone case device with knife blade of claim 1, wherein the second button engages the locking member when pressed.

10. The cell phone case device with knife blade of claim 1, wherein the third button releases the deploying mechanism when pressed.

11. A cell phone case device with knife blade comprising:
a cell phone case body comprised of an opening, a light, a speaker, and a battery;
a blade attached to a deploying mechanism, the deploying mechanism attached to the body;
a first button;
a second button;
a third button;
a fourth button; and
a locking member.

12. The cell phone case device with knife blade of claim 11, wherein the deploying mechanism is comprised of a spring.

13. The cell phone case device with knife blade of claim 11, wherein the locking member locks the blade in an extended or a retracted position relative to the body.

14. The cell phone case device with knife blade of claim 11, wherein the first button disengages the locking member when pressed.

15. The cell phone case device with knife blade of claim 11, wherein the second button engages the locking member when pressed.

16. The cell phone case device with knife blade of claim 11, wherein the third button releases the deploying mechanism when pressed.

17. The cell phone case device with knife blade of claim 11, wherein the fourth button activates the light and/or the speaker when pressed.

18. The cell phone case device with knife blade of claim 11, wherein the light illuminates continuously or intermittently.

19. The cell phone case device with knife blade of claim 11, wherein the speaker produces a sound.

20. A method of using a cell phone case device with knife blade, the method comprising the following steps:
providing a cell phone case device with knife blade comprised of a cell phone case body comprised of a blade that can be extended from and retracted into the body via a deploying mechanism;
placing the body around a cell phone;
pressing a first button of the cell phone case device with knife blade to activate the deploying mechanism to extend the blade from the body via an opening of the body; and
pressing a second button of the cell phone case device with knife blade to disengage a locking member of the cell phone case device with knife blade to allow the blade to be automatically or manually retracted into the body via the deploying mechanism.
